(19) United States
(12) Patent Application Publication
(10) Pub. No.: US 2006/0082530 A1
(43) Pub. Date: Apr. 20, 2006

(54) Liquid crystal screen display method

(76) Inventors: Cheng-Jung Chen, Chu-Nan County (TW); Liang-Chen Chien, Chu-Pei City (TW); Chang-Cheng Lin, Taipei (TW)

Correspondence Address: SUPREME PATENT SERVICES, P.O. BOX 2339, SARATOGA, CA, 95070-0339, US

(21) Appl. No.: 10/965,946

(22) Filed: Oct. 14, 2004

(51) Int. Cl. G09G 3/36

(52) U.S. Cl. 345/87

(57) ABSTRACT

Disclosed is a liquid crystal screen display method, such that when displaying the images each composed of the temporal sequence of frames on the liquid crystal screen, the darkening frames are inserted between the said frames, and each darkening frame is darker than the previous frame.

### BACKGROUND OF THE INVENTION

1. Field of the Invention

The present invention relates to a liquid crystal screen display method, and in particular to a liquid crystal screen display method of inserting darkening frames.

2. The Prior Arts

Until recently, numerous methods have been proposed to increase the gray level response speed of a liquid crystal display (LCD). Among these methods, the most popular and preferred one is the so-called Pseudo Impulse Drive (PID). As the name suggests, the Pseudo Impulse Drive Method is used to drive the liquid crystal display by simulating impulse drive display manner of a cathode ray tube display so as to make the display effects of LCD similar to those of CRT.

FIG. 1 of the attached drawings schematically illustrates a conventional PID method, wherein a displayed image is composed of sequentially displayed frames 1, 2, 3, and 4. A first PID method achieves its purpose by inserting completely dark data frames 11, 12, and 13 between frames 1 and 2, frames 2 and 3, and frames 3 and 4 respectively with the backlight in the illumination state at time points 14-20 corresponding to those of the afore-mentioned frames respectively. The first PID method makes use precisely of this technology to achieve the purpose of pseudo impulse displaying effect.

However, in driving the liquid crystal display on the screen using the PID method as mentioned above, if the frame replenishment rate of the liquid crystal screen is merely 60 Hz, then under this condition of variation frequency it is liable that the flicker phenomenon displayed by the screen will easily be recognized by the human eye, when the completely dark data frames 11,12 and 13 are inserted between the frames 1 and 2, frames 2 and 3, and frames 3 and 4 respectively. Besides, it is liable that the illuminance of the liquid crystal screen will be reduced to 50% of its original value, since the completely dark data frame 11 is first inserted and displayed before the display of the ordinary display frame 2. Therefore, the adoption and utilization of this kind of PID driven liquid crystal screen will require the significant increase of the light emission efficiency of backlight, so as to compensate for the loss of illuminance of the screen.

### SUMMARY OF THE INVENTION

Therefore, a primary objective of the present invention is to provide a liquid crystal screen display method, wherein the flicker phenomenon can be avoided by inserting the darkening frames.

Another objective of the present invention is to provide a liquid crystal screen display method, which by inserting the darkening frames between the ordinary frames, is able to avoid the necessity of having to utilize the backlight of better light emission efficiency and hence raise the additional production cost, as a result of the over-reduction of the screen display illuminance.

Based on the above-mentioned purpose, the present invention provides a liquid crystal screen display method, such that the image displayed on the liquid crystal screen is composed of the temporal sequence of frames, and this purpose is achieved by inserting the darkening frames between the ordinary frames, wherein the darkening frame is darker as compared with the previous frame.

The advantage and spirit of the present invention can be understood more thoroughly by the following detailed descriptions together with the attached drawings.

### BRIEF DESCRIPTION OF THE DRAWINGS

The related drawings in connection with the detailed description of the present invention to be made later are described briefly as follows, in which:

FIG. 1 is a schematic diagram of a conventional pseudo impulse drive method;

FIG. 2 is a schematic diagram of a liquid crystal screen display method according to the present invention;

FIGS. 3A and 3B are schematic diagrams of an input darkening signal processing device according to the present invention.

### DETAILED DESCRIPTION OF THE PREFERRED EMBODIMENT

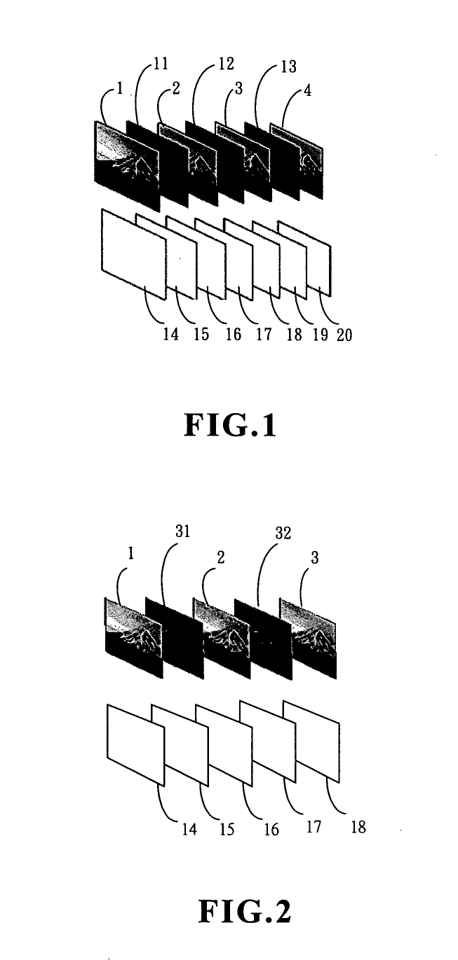

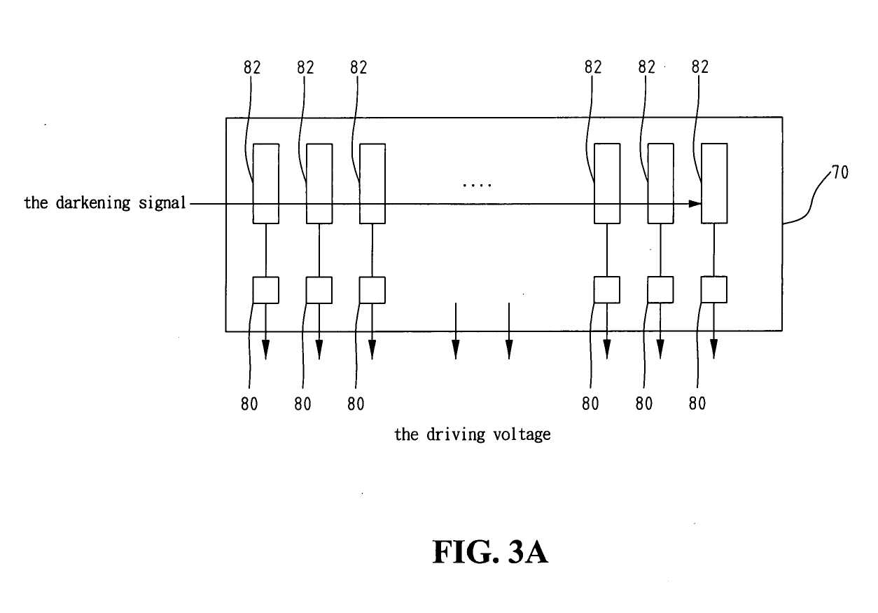

With reference to the drawings and in particular to FIG. 2, a liquid crystal screen display method according to the present invention is illustrated. The liquid crystal screen display method of the present invention replaces the completely dark data frames 11 and 12 of the prior art as shown in FIG. 1 with the darkening frames 31 and 32 of the present invention.

It is known that the video images displayed on the liquid crystal screen are composed of the temporal sequence of frames 1, 2, and 3. Therefore, by inserting the darkening frames 31 and 32 between frames 1 and 2 and between frames 2 and 3 respectively, it can not only achieve another configuration of PID, raising the LCD gray level response speed, but also significantly improve the phenomenon of flicker and the problem of screen illuminance over-reduction.

Simply speaking, the so-called darkening frame 31 refers to the frame, which is darker as compared with the previous frame 1. And concretely speaking, if the screen is about to display the darkening frame 31 as shown in FIG. 2, then the pixel value for every pixel in the darkening frame 31 is obtaining by multiplying the pixel value of the corresponding pixel point in frame 1 by 1/N, wherein N is the positive integer above 0.

The color of the frame is deeper and darker as the numeric value of pixel value becomes smaller. Therefore, as the value of N becomes larger, and since the pixel value of the pixel point in the darkening frame 31 is obtained by multiplying the pixel value of the corresponding pixel point in frame 1 by 1/N, the illiminance of the darkening frame 31 is very close to that of the completely dark data frame 11 as shown in FIG. 1. On the contrary, as the value of N becomes smaller, then the darkening frame 31 or 32 will more tend to not to change the pixel value of the original pixel point in frame 1, namely, the image displayed by the darkening frame 31 tends to resemble closer to the image displayed by the conventional hold-type liquid crystal screen. Therefore, the determination of the magnitude of value N depends on the requirements that its displaying effects must be better than the hold-type liquid crystal screen display, but its flicker phenomenon and the problem of screen illuminance over-reduction will not be as serious as those incurred by the completely dark data frames 11 or 12.

Summing up the above, in the liquid crystal screen display method provided by the present invention, the darkening frame 31 or 32 is utilized to replace the completely dark data frame 11 or 12. Since the illuminance of the darkening frames 31 and 32 can be adjusted by adjusting the value of N, the flicker phenomenon due to utilizing PID can be avoided. Meanwhile, the screen illuminance over-reduction incurred by adopting PID can also be avoided, and thus the additional cost of using the backlight of better light emission efficiency can further be avoided.

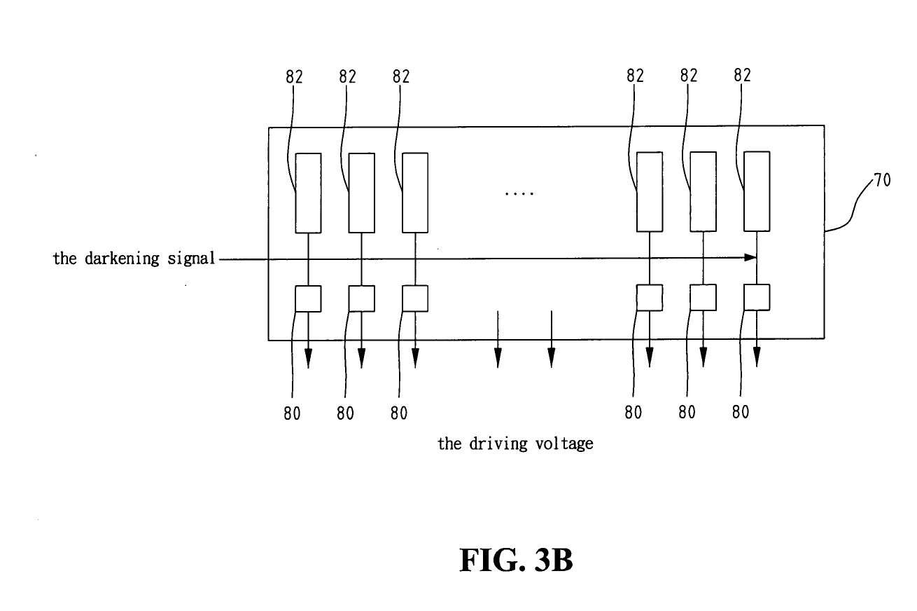

Also referring to FIGS. 3A and 3B, which illustrate an input darkening signal processing device in accordance with the present invention, the basic structure of the data driver 70 according to the prior art at least comprises a plurality sets of digital-to-analogue (DAC) converters 80 and data recorders 82. The required number of data lines connected to each data driver 70, and the number of sets of digital-to-analogue (DAC) converters 80 and data recorders 82 all depend on the resolution requirement of the liquid crystal display panel.

Since in the liquid crystal screen display method adopted by the present invention, there are additionally added darkening frames 31 and 32 in addition to the ordinary frames 1 to 3, thus resulting in doubling the scanning frequency of the data driver 70 to be twice that of the prior art, and as such it is liable to generate EMI (electric magnetic interference), and the data frequency bandwidth required will also be increased. Therefore, in order to avoid the necessity that the scanning frequency of the data driver 70 must be increased so as to be able to display the darkening frames 31 and 32, the data driver 70 is connected to the darkening control lines to receive the darkening signals.

The darkening control line is connected to the data recorder 82. When data driver 70 is about to output the driving voltage used for generating the darkening frame 31 or 32, and upon receiving the darkening signal, the data recorder 82 in the data driver 70 converts the pixel data value stored temporarily in the data recorder 82 into 1/N of the pixel value of the corresponding pixel point in the previous frame 1 or 2, and it will hold this value in the data recorder 82 until displaying the complete darkening frame 31 or 32. Therefore, when this converted digital signal is in digital-to-analogue (DAC) converter 80, the driving voltage it outputs is used for generating the darkening frame 31 or 32. As such, there is no need of temporarily storing the data of the darkening frame 31 or 32 in the data recorder 82 in advance. Instead, the previous pixel data stored therein is changed, and thus indirectly enabling the data driver 70 to output the driving voltage used for generating the darkening frame 31 or 32 through the darkening signals in the same manner.

The darkening control line is connected between the data recorder 82 and the digital-to-analogue converter 80. Therefore, when the data driver 70 is about to output the driving voltage used for generating the darkening frame 31 or 32, then any element between data recorder 82 and the digital-to-analogue converter 80 (including the digital-to-analogue converter 80), upon receiving the darkening signal, will convert the digital signal, namely the pixel data in the digital-to-analogue converter 80, into 1/N of the original pixel value. Upon being converted into 1/N of the original value, then this digital signal will be converted into analogue signal through the digital-to-analogue converter 80. As such, there is no need of temporarily storing the darkening frame 31 or 32 in the data recorder 82 in advance. Instead, the data driver 70 is indirectly enabled to output the driving voltage used for generating the darkening frame 31 or 32 through the darkening signals in the same manner.

The spirit and characteristics of the present invention are more evident through the detailed descriptions of the preferred embodiment given above. However, the preferred embodiment disclosed above is not intended to be construed as to be any restrictions to the scope of the present invention. On the contrary, it is intended to cover the various changes and the equivalent arrangements that fall into the scope of the appended claims.

What is claimed is:

1. A liquid crystal screen display method, wherein the liquid crystal screen is used to display video images, and the image is composed of temporal sequence of frames, and is characterized in that a darkening frame is inserted between the frames, and the darkening frame is darker than a previous frame.

2. The method as claimed in claim 1, wherein pixel value of each pixel point of the darkening frame is 1/N of the pixel value of the corresponding pixel point in the previous frame.

3. The method as claimed in claim 2, wherein N is a positive integer of 0 or above.

4. The method as claimed in claim 1, wherein the liquid crystal screen contains a data driver, the said data driver is connected to a darkening control line to receive the darkening signal, when the data driver is about to output the driving voltage used for generating the said darkening frame, and the data driver simultaneously converts the pixel data stored temporarily in one of a plurality of data recorders contained therein, into 1/N of the pixel value of the corresponding pixel point in the previous frame, until the display of the entire darkening frame.
